(19) United States
(12) Patent Application Publication
(10) Pub. No.: US 2026/0054405 A1
(43) Pub. Date: Feb. 26, 2026

(54) SELF-ROLLING TUBE IRONING CUTTING DEVICE

(71) Applicant: APTIV ELECTRIC SYSTEMS COMPANY LTD., SHANGHAI (CN)

(72) Inventors: Guoping ZHANG, SHANGHAI (CN); Hui LI, SHANGHAI (CN)

(21) Appl. No.: 19/308,401

(22) Filed: Aug. 25, 2025

(30) Foreign Application Priority Data
Aug. 23, 2024 (CN) 202411171347.2

(51) Int. Cl. B26D 1/62

(52) U.S. Cl. CPC B26D 1/62

(57) ABSTRACT

A self-rolling tube ironing cutting device includes a main frame, a positioning member disposed on the main frame and extending along a first direction to pass through a self-rolling tube such that the tube is wound around the member with portions on opposite first and second surfaces. The positioning member comprises first and second positioning sections spaced apart along the first direction. An ironing cutting module is configured to cut the self-rolling tube at a location between the first and second positioning sections.

### CROSS-REFERENCE TO RELATED APPLICATION

This application claims the benefit of and priority to Chinese Patent Application No. 202411171347.2, titled “Self-rolling Tube Ironing Cutting Device”, filed Aug. 23, 2024, the contents of which are incorporated by reference herein.

### TECHNICAL FIELD OF THE INVENTION

This disclosure belongs to the field of cable processing technology and specifically relates to an ironing cutting apparatus for self-rolling tube.

### BACKGROUND

With the continuous development of automobiles and the rapid increase of electric vehicles, the number of cables to be used has also increased, and the requirements for cable protection have become more stringent and lightweight. At present, some cables have an extra layer of braided self-rolling tube outside the cable for safety reasons, in order to improve the safety and reliability of cable. Therefore, it is necessary to perform ironing cutting for the braided self-rolling tube according to the length of the cable. However, the current ironing cutting apparatus has the problem that the self-rolling tube is prone to deformation and sticking after ironing cutting, resulting in increased labor costs.

### SUMMARY

The embodiments of this disclosure provide an ironing cutting apparatus for self-rolling tube, aiming to solve the technical problem of deformation and adhesion of self-rolling tube after ironing cutting.

The present disclosure proposes a self-rolling tube ironing cutting device including a main framework and a positioning member disposed on the main frame and extending along a first direction and spaced apart in the first direction. The positioning member has a first surface and a second surface that are opposite to each other. The positioning member is configured to pass through the self-rolling tube such that the tube is wound around the positioning member. At least a part of the self-rolling tube is located on the first surface and at least another part of the self-rolling tube is located on the second surface. The positioning member includes a first positioning section and a second positioning section adjacent to and spaced apart from the first positioning section. The self-rolling tube ironing cutting device further including an ironing cutting module configured to cut off the self-rolling tube at a location between the first positioning section and the second positioning section.

The self-rolling tube ironing cutting device effectively prevents deformation of the self-rolling tube by winding the self-rolling tube around the positioning member. Disposing the self-rolling tube on the inner and outer walls of the positioning member can avoid contact between overlapping portions of the self-rolling tube and prevent them from sticking to each other or causing wire drawing during ironing cutting. The use of positioning member can effectively reduce labor costs.

### BRIEF DESCRIPTION OF THE DRAWINGS

In order to provide a clearer explanation of the technical solution in the embodiments of the present disclosure, a brief introduction will be given to the drawings required for the description of the embodiments. It is apparent that the drawings described below are only some embodiments of the present disclosure. For those skilled in the art, other drawings can be obtained based on these drawings without creative labor.

FIG. 1 is a schematic diagram of the structure of a self-rolling tube ironing cutting device according to some embodiments.

FIG. 2 is a schematic diagram of the structure of a self-rolling tube ironing cutting device according to some embodiments.

FIG. 3 is a schematic diagram of the structure of a self-rolling tube ironing cutting device according to some embodiments.

FIG. 4 is a schematic diagram of the structure of an ironing cutting module according to some embodiments.

FIG. 5 is a schematic diagram of the structure of a first feeding mechanism according to some embodiments.

FIG. 6 shows an illustrative structure of a positioning member in the form of P-shaped mandrel, which is wrapped by braided self-rolling tube according to some embodiments.

### DETAILED DESCRIPTION

The following will provide a clear and complete description of the technical solution in the embodiments of the present disclosure, in conjunction with the accompanying drawings. Obviously, the described embodiments are only a part of the embodiments of the present disclosure, not all of them. Based on the embodiments in this disclosure, all other embodiments obtained by those skilled in the art without creative labor are within the scope of protection of this disclosure.

In the description of this disclosure, it should be understood that the terms “length”, “width”, “thickness”, “up”, “down”, “front”, “back”, “left”, “right”, “top”, “bottom”, “inside”, “outside” and other directional or positional relationships indicated are based on the directional or positional relationships shown in the accompanying drawings, only for the convenience of describing this disclosure and simplifying the description, and do not indicate or imply that the device or component referred to must have a specific orientation, be constructed and operated in a specific orientation, and therefore cannot be understood as a limitation of this disclosure. In addition, the terms “first” and “second” are only used for descriptive purposes and cannot be understood as indicating or implying relative importance or implying the number of technical features indicated. Thus, the features limited to “first” and “second” may explicitly or implicitly include one or more features. In the description of this disclosure, “multiple” means two or more, and at least one refers to one, two, or more, unless otherwise specifically limited. In the description of this disclosure, “vertical” refers to being completely perpendicular at 90° or almost completely perpendicular, for example, within the range of 80° to 100°, it is considered perpendicular. Similarly, “parallel” refers to being completely parallel or almost completely parallel, for example, within the range of 10°, it is considered parallel.

As mentioned in the background technology section, with the continuous development of automobiles and the rapid increase of electric vehicles, the number of cables to be used has also increased, and the requirements for cable protection have become more stringent and lightweight. At present, some cables have an extra layer of braided self-rolling tube outside the cable for safety reasons, in order to improve the safety and reliability of cable. Therefore, it is necessary to perform ironing cutting for the braided self-rolling tube according to the length of the cable. However, the current ironing cutting apparatus has the problem that the self-rolling tube is prone to deformation and sticking after ironing cutting, resulting in increased labor costs.

In view of this, the embodiments of the present disclosure provide a self-rolling tube ironing cutting device, including a main frame, a positioning member, and an ironing cutting module. Below, with reference to the accompanying drawings, a detailed description of the self-rolling tube ironing cutting device in this disclosure will be provided. In the absence of conflict, the features in the following embodiments and implementation methods can be combined with each other.

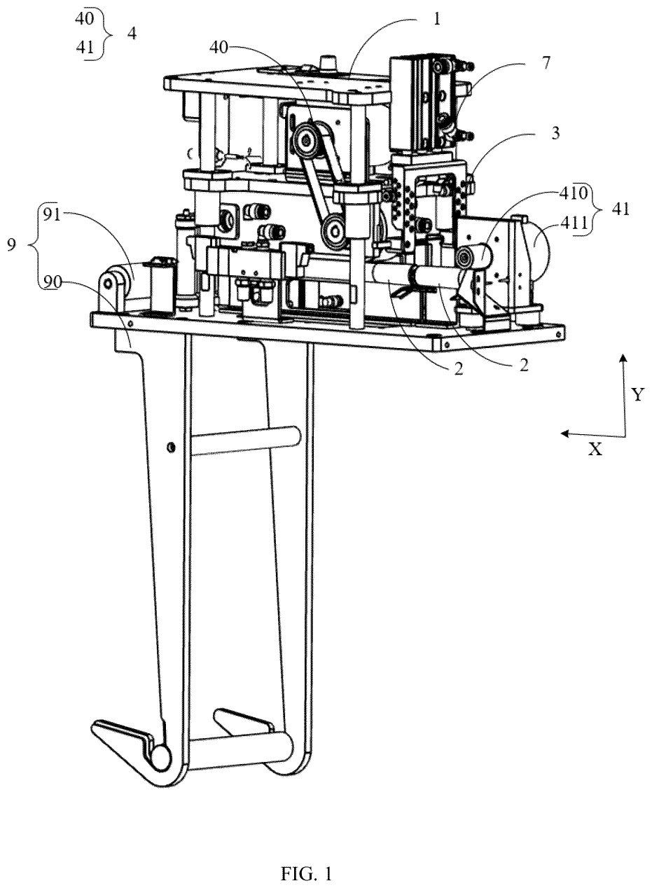

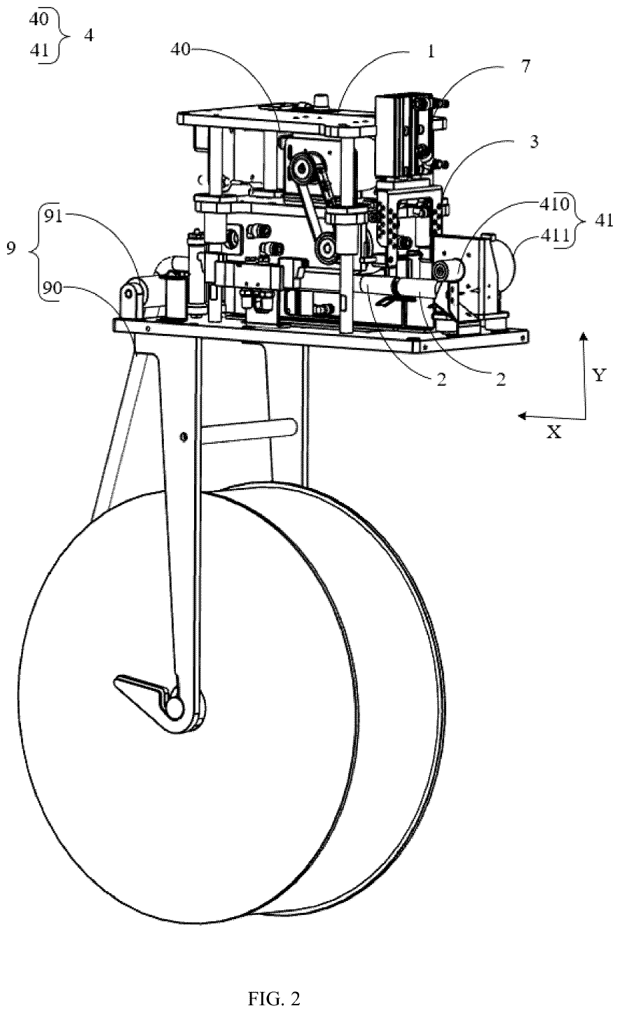

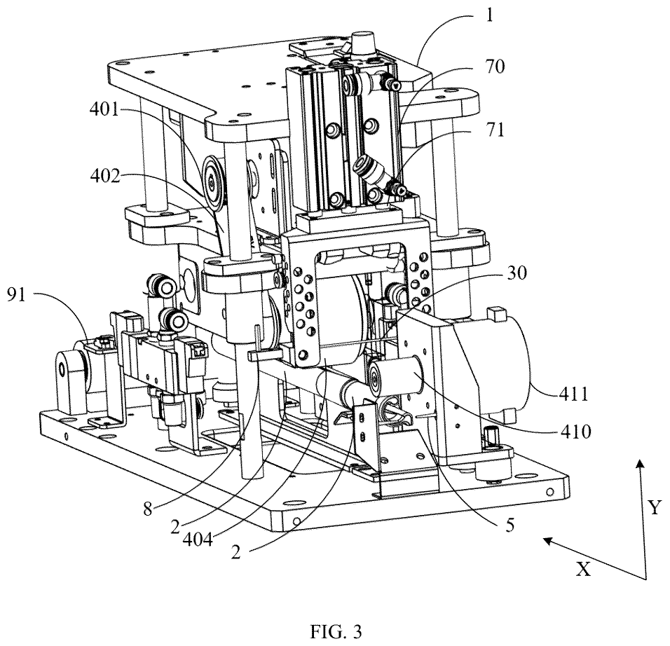

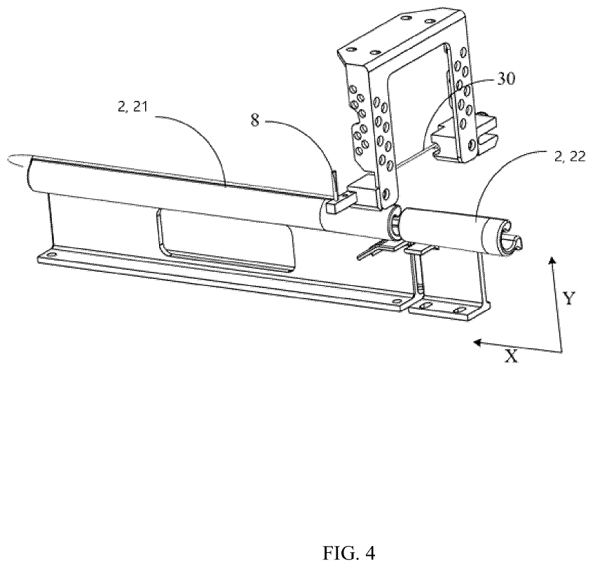

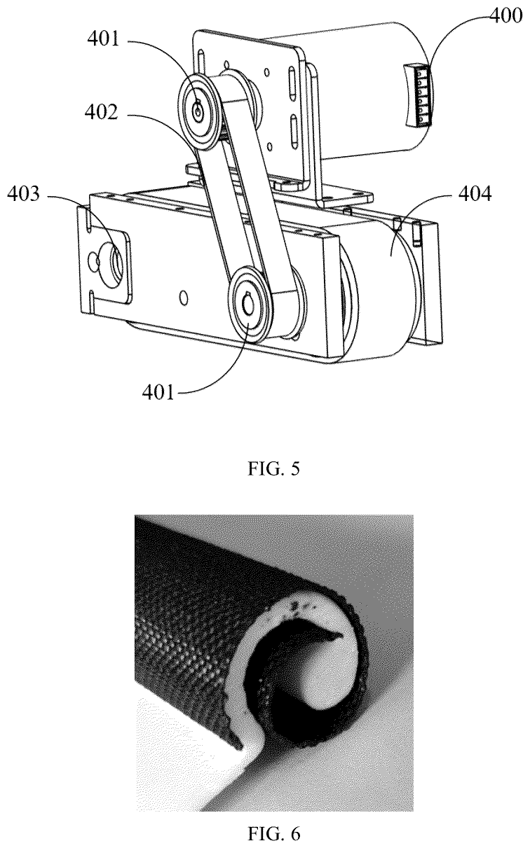

FIG. 1 is a schematic diagram of the structure of a self-rolling tube ironing cutting device according to an embodiment of the present disclosure. FIG. 2 is a schematic diagram of the structure of a self-rolling ironing cutting device according to another embodiment of the present disclosure. FIG. 3 is a schematic diagram of the structure of a self-rolling ironing cutting device according to another embodiment of the present disclosure. FIG. 4 is a schematic diagram of the structure of an ironing cutting module 3 according to an embodiment of the present disclosure. FIG. 5 is a schematic diagram of the structure of a first feeding mechanism 40 according to an embodiment of the present disclosure.

Referring to FIGS. 1 to 5, the present embodiment provides an ironing cutting device for cutting a self-rolling tube, including a main frame 1, a positioning member 2, and an ironing cutting module 3. The positioning member 2 is arranged on the main frame 1, extending along a first direction X and spaced apart in the first direction X. The positioning member 2 has a first surface and a second surface that are opposite to each other. The positioning member 2 is used to pass through the self-rolling tube so as to wind the tube around the positioning member 2, and at least a part of the self-rolling tube is located on the first surface, while at least another part of the self-rolling tube is located on the second surface. Winding the self-rolling tube around the positioning member 2 can effectively prevent deformation of the self-rolling tube. Setting the self-rolling tube on the inner and outer walls of the positioning member 2 can avoid contact between the overlapping portions of the self-rolling tube and prevent them from sticking to each other or causing wire drawing during thermal cutting. The use of positioning member 2 can effectively reduce labor costs without the need for manual tearing of the adhesive parts of the self-rolling tube.

For example, the self-rolling tube is a braided sheath layer which can provide protection for the cable. Specifically, the braided sheath layer can effectively improve the wear resistance of the cable, increase the overall strength of the cable, and prevent the cable from becoming loose. The braided sheath layer is usually made of fiber materials or synthetic fibers, which may easily melt or deform at high temperatures, leading to adhesion. The positioning member 2 of the present embodiment is spiral shaped. Specifically, the positioning member 2, in its cross-section, extends in a spiral shape from its inside towards its outside, and the self-rolling tube is sleeved on the positioning member 2, so as to maintain the relative positional stability of the self-rolling tube, avoiding misalignment or detachment of the self-rolling tube and effectively preventing deformation of the self-rolling tube. The positioning member 2 has a first surface and a second surface that are opposite to each other. The first surface may be the inner wall of the positioning member 2, and the second surface may be the outer wall of the positioning member 2. The self-rolling tube can be wound around the first surface and the second surface of the positioning member 2 to avoid contact between the overlapping portions of the tube and prevent them from sticking to each other or causing wire drawing during the ironing cutting process.

In some embodiment, the positioning member 2 is a mandrel, the self-rolling tube is sleeved on the mandrel such that the overlapping portions of the wound tube have no direct contact.

In some embodiments, the material of the positioning member 2 may be stainless steel, titanium alloy, or other metals. Stainless steel and titanium alloy have advantages such as wear resistance, resistance to rust, and high strength, which help to improve the service life and performance stability of the positioning member 2.

In some embodiments, the self-rolling tube ironing cutting device includes a feeding mechanism 9, which is disposed on the main frame 1 and used to transport the self-rolling tube towards the positioning member 2. The self-rolling tube ironing cutting device also includes a feeding module 4, which is disposed on the main frame 1. The feeding module 4 includes a first feeding mechanism 40 and a second feeding mechanism 41. The first feeding mechanism 40 is used to transport the tube from one positioning member 2 to the adjacent positioning member 2, and the second feeding mechanism 41 is used to send out the cut tube from the positioning member 2.

In the embodiment shown in FIG. 2, the feeding mechanism 9 includes a frame 90 and a shaft 91. The shaft 91 is arranged between the frame 90 and the positioning member 2. The frame 90 is connected to the main frame 1 and is arranged on a side of the main frame 1 away from the positioning member 2 and the ironing cutting module 3. The frame 90 is used to place uncut self-rolling tube. In the embodiments of the present disclosure, the self-rolling tube can be wound and disposed on the rack for 90 degrees. Under the action of the shaft 91 and the first feeding mechanism 40, the self-rolling tube is transported to the positioning member 2, so that the self-rolling tube is wound around the positioning member 2. The shaft 91 and the first feeding mechanism 40 cooperate to achieve the conveying and motion control of the self-rolling tube, which helps ensure the accurate positioning and stable conveying of the self-rolling tube, and provides a reliable foundation for the subsequent cutting operation by the ironing cutting module 3.

In some embodiments, the working principle of the ironing cutting device for the self-rolling tube is as follows: the uncut self-rolling tube is conveyed to the positioning member 2 through the feeding mechanism 9, and then the first feeding mechanism 40 continues to convey the self-rolling tube set on one positioning member 2 along the first direction X to the adjacent positioning member 2. When the self-rolling tube is moved to the set position, control the ironing cutting module 3 to cut the self-rolling tube along the gap between adjacent positioning pieces 2. The second feeding mechanism 41 continues to transport the cut tube forward to separate it from the positioning member 2, facilitating the collection of tubes for subsequent processes. By setting the positioning member 2 in this way, it is possible to effectively prevent deformation and adhesion of the self-rolling tube, without the need for manual tearing of the adhesive part of the self-rolling tube, thus simplifying the process flow and improving production efficiency.

In the embodiment shown in FIG. 5, the first feeding mechanism 40 includes a first driving component 400, multiple synchronous belt pulleys 401, a synchronous belt 402, multiple rotating shafts 403, and a conveyor belt 404. The first driving component 400 is connected to at least one synchronous belt pulley 401, and at least one other synchronous belt pulley 401 is connected to the rotating shaft 403. The synchronous belt 402 is arranged on the outer circumference of the multiple synchronous belt pulleys 401, and the conveyor belt 404 is arranged on the outer circumference of the multiple rotating shafts 403. The conveyor belt 404 is spaced apart from the positioning member 2. The first driving component 400 is used to drive the synchronous belt pulley 401 and the rotating shaft 403 connected to the synchronous belt pulley 401 to rotate. The rotating shaft 403 is used to drive the conveyor belt 404 to drive the uncut tube on the positioning member 2 along the first direction X to move.

As an illustration, the multiple synchronous belt pulleys 401 include an active wheel and a driven wheel, and the multiple rotating shafts 403 include an active shaft and a driven shaft. The first driving component 400 drives the active wheel and the synchronous belt 402 connected to the active wheel to rotate. The synchronous belt 402 drives the driven wheel to rotate, and the driven wheel is connected to the active shaft to drive the active shaft and the conveyor belt 404 connected to the active shaft to rotate. The conveyor belt 404 drives the driven shaft to rotate. In this way, the conveyor belt 404 can come into contact with the self-rolling tube on the positioning member 2 and drive the self-rolling tube to move along the first direction X. This setting achieves multi-point driving and synchronous transmission to provide a stable conveying process, reduce the swing of conveyor belt 404, and ensure the stability and balance of the self-rolling tube during the conveying process.

In the embodiments shown in FIGS. 1 to 3, the self-rolling tube ironing cutting device includes a first sensor 5 and a control module (not shown). The first sensor 5 is used to send the position information of the self-rolling tube to the control module, and the control module is used to control the operation of the first feeding module 4 based on the received position information of the tube. By controlling the opening and stopping time of the first feeding mechanism 40 and the feeding speed, the length of the cut self-rolling tube can be effectively controlled. The control module receives the position information of the tube and automatically controls the operation of the first driving component 400. By using the first sensor 5 and the control module, the cutting process can be automated, reducing the need for manual operation and improving production efficiency.

As an illustration, the first driving component 400 can be a servo motor, which has fast response and adjustment capabilities. After receiving instructions from the control module, it can quickly adjust the output torque and speed of the servo motor to meet the cutting needs of different lengths of tube. This setting can improve the response speed and efficiency of the cutting process.

In the embodiments shown in FIGS. 1 to 3, the second feeding mechanism 41 includes a roller 410 and a second driving component 411. The roller 410 is connected to the second driving component 411 and is spaced apart from the positioning member 2. The roller 410 is used to feed out the cut self-rolling tube on the positioning member 2. In the embodiment of the present disclosure, after the self-rolling tube wound on the positioning member 2 reaches the set position, the control module drives the ironing cutting module 3 to cut the self-rolling tube along the gap between adjacent positioning sections of the positioning member 2. In some embedment, as shown in FIG. 4, the adjacent positioning sections of the positioning member 2 includes a first positioning section 21, and a second positioning section 22 adjacent to but spaced apart from the first positioning section 21. The cut self-rolling tube is moved along the first direction X by roller 410 to separate from the positioning member 2 and proceed with subsequent processes.

In the embodiments shown in FIGS. 1 to 3, the self-rolling tube ironing cutting device includes a first sensor 5 and a control module. For example, the first sensor 5 may be a displacement sensor. The first sensor 5 is used to send the position information of the self-rolling tube to the control module, and the control module is used to control the operation of the second feeding module 4 based on the received position information of the self-rolling tube. By controlling the stop of the second feeding mechanism 41, the ironing cutting module 3 is allowed to cut off the self-rolling tube, and after completing the cutting of the self-rolling tube, the second feeding mechanism 41 is controlled to actuate to send out the self-rolling tube. The control module receives the position information of the self-rolling tube and automatically controls the operation of the second driving component 411. By using the first sensor 5 and the control module, the cutting process can be automated, reducing the need for manual operation and improving production efficiency.

As an illustration, the second driving component 411 can be a servo motor, which has fast response and adjustment capabilities. The second driving component 411 is connected to the roller 410, and by driving the operation of the roller 410, the cut self-rolling tube on the positioning member 2 (particularly, on the second positioning section 22) is sent out. The servo motor can control the speed and direction of roller 410, ensuring smooth separation of the tube from the positioning member 2 (particularly, separation form the second positioning section 22) and movement along the first direction X for subsequent processes. With the position information of the self-rolling tube received by the control module, the servo motor can accurately drive the operation of roller 410, ensuring that the self-rolling tube is accurately separated after cutting and moves along the first direction X as needed, achieving precise feeding.

In the embodiments shown in FIGS. 1 to 3, the self-rolling tube ironing cutting device includes a lifting mechanism 7, which is connected to the ironing cutting module 3. The lifting mechanism 7 is used to control the ironing cutting module 3 to move along the second direction Y to cut the self-rolling tube, and the second direction Y intersects with the first direction X. In the embodiments of the present disclosure, the first direction X and the second direction Y are perpendicular to each other. By controlling the lifting motion of the lifting mechanism 7, the contact and separation between the ironing cutting module 3 and the self-rolling tube can be controlled, achieving the cutting operation of the self-rolling tube. By precisely controlling the contact and separation between the ironing cutting module 3 and the rolling tube, the cutting quality and accuracy are ensured. Avoid deformation and sticking at the cutting point of the self-rolling tube to improve production quality.

In some embodiments, the lifting mechanism 7 includes a cylinder 70 and a telescopic shaft 71. The telescopic shaft 71 is connected to the ironing cutting module 3 on the side facing the positioning member 2, and the cylinder 70 is used to control the lifting and lowering of the telescopic shaft 71. In the embodiment of the present disclosure, the cylinder 70 is used to control the lifting motion of the telescopic shaft 71, thereby controlling the movement of the ironing cutting module 3 connected to the telescopic shaft 71 along the second direction Y. By controlling the lifting motion of the ironing cutting module 3 through cylinder 70, it is possible to achieve contact and separation between the ironing cutting module 3 and the self-rolling tube. Cylinder 70 has a fast response characteristic and can quickly adjust the lifting motion of the telescopic shaft 71. According to the received control signal, cylinder 70 can quickly adjust the lifting speed and position of telescopic shaft 71 to meet real-time cutting operation requirements.

In some embodiments, the tube ironing cutting device includes a second sensor 8 and a control module, and for example, the second sensor 8 may be a displacement sensor. The second sensor 8 is installed in the ironing cutting module 3 and is used to send the position information of the ironing cutting module 3 to the control module. The control module is used to control the operation of the lifting mechanism 7 based on the received position information of the ironing cutting module 3. The control module can achieve precise control of the lifting mechanism 7 based on the received position information of the ironing cutting module 3. The control module uses feedback signals to control the lifting mechanism 7, achieving accurate cutting of the self-rolling tube, thereby improving the accuracy, stability, and production efficiency of cutting the self-rolling tube.

In the embodiment shown in FIG. 5, the ironing cutting module 3 includes a resistance wire 30 and a heating controller (not shown). The heating controller is used to heat the resistance wire 30, and the resistance wire 30 is used to cut the self-rolling tube. The resistance wire 30 can be used as a cutting tool and is to be heated by the heating controller. During the cutting process, it directly contacts and cuts the self-rolling tube. The heating of resistance wire 30 reaches a sufficient temperature to cut off the self-rolling tube, thereby achieving the cutting operation of the self-rolling tube. Due to the precise adjustment of heating and control parameters for resistance wire 30, the cutting process can be optimized based on the characteristics of the self-rolling tube and cutting requirements. This can ensure that the incision of the self-rolling tube is smooth, free of burrs or damage, thereby improving the cutting quality.

In some embodiments, in order to ensure the safety of the heating process, a protective cover (not shown) is fitted and fixedly connected to the outer periphery of the main frame 1. The configuration of the protective cover can prevent material splashing or cutting waste from flying out during work, providing safety protection and protection.

According to the embodiment, the positioning element 2 can be a mandrel. As shown in FIG. 4, the mandrel can be a P-shaped mandrel. An illustration of the P-shaped mandrel (wrapped by braided self-rolling tube) can be further seen from FIG. 6.

In the above embodiments, the description of each embodiment has its own emphasis. For the parts that are not detailed in one embodiment, please refer to the relevant descriptions of other embodiments.

The disclosure provides a detailed introduction to the tube ironing cutting device provided in the embodiments of the present disclosure and applies specific examples to explain the principles and implementation methods of the present disclosure. The above embodiments are only used to help understand the technical solution and core idea of the present disclosure; Ordinary technical personnel in this field should understand that they can still modify the technical solutions described in the aforementioned embodiments, or equivalently replace some of the technical features; And these modifications or substitutions do not deviate from the essence of the corresponding technical solutions from the scope of the technical solutions of the various embodiments of the present disclosure.

1. A self-rolling tube ironing cutting device, comprising:
a main frame;
a positioning member disposed on the main frame, extending along a first direction and spaced apart in the first direction, the positioning member has a first surface and a second surface that are opposite to each other, the positioning member is to pass through the self-rolling tube such that the tube is wound around the positioning member, and at least a part of the self-rolling tube is located on the first surface, and at least another part of the self-rolling tube is located on the second surface, the positioning member comprises a first positioning section and a second positioning section adjacent to and spaced apart from the first positioning section; and
an ironing cutting module configured to cut off the self-rolling tube at a location between the first positioning section and the second positioning section.

2. The self-rolling tube ironing cutting device according to claim 1, further comprising a feeding module disposed on the main frame, and the feeding module comprises a first feeding mechanism and a second feeding mechanism, wherein the first feeding mechanism is used to transport the self-rolling tube on the first positioning section to the second positioning section, and the second feeding mechanism is used to send out the cut self-rolling tube on the positioning member.

3. The self-rolling tube ironing cutting device according to claim 2, wherein the first feeding mechanism comprises a first driving element, multiple synchronous belt pulleys, a synchronous belt, multiple rotating shafts, and a conveyor belt, wherein the first driving element is connected to at least one synchronous belt pulley, at least another synchronous belt pulley is connected to the rotating shaft, the synchronous belt is arranged on an outer circumference of multiple synchronous belt pulleys, and the conveyor belt is arranged on the outer circumference of multiple rotating shafts, the conveyor belt is spaced apart from the positioning member, and the first driving member is used to drive the synchronous pulley and the rotating shaft connected to the synchronous pulley to rotate, the rotating shaft is used to drive the conveyor belt to move the uncut self-rolling tube on the positioning member along the first direction.

4. The self-rolling tube ironing cutting device according to claim 2, wherein the second feeding mechanism comprises a roller and a second driving element, the roller is connected to the second driving element, the roller is spaced apart from a positioning element, and the roller is used to send out the self-rolling tubes cut on the positioning element.

5. The self-rolling tube ironing cutting device according to claim 2, further comprising a first sensor and a control module, wherein the sensor is used to send position information of the self-rolling tube to the control module, and the control module is used to control operation of the feeding module based on received position information of the self-rolling tube.

6. The self-rolling tube ironing cutting device according to claim 1, further comprising a lifting mechanism, which is connected to the ironing cutting module, and is used to control the ironing cutting module to move along a second direction to cut off the self-rolling tube, wherein the second direction intersects with the first direction.

7. The self-rolling tube ironing cutting device according to claim 6, wherein the lifting mechanism comprises a cylinder and a telescopic shaft, wherein the telescopic shaft is connected to the ironing cutting module on one side facing the positioning member, and the cylinder is used to control the lifting and lowering of the telescopic shaft.

8. The self-rolling tube ironing cutting device according to claim 6, further comprising a second sensor and a control module, the second sensor is disposed on the ironing cutting module, and is used to send position information of the ironing cutting module to the control module, the control module is used to control operation of the lifting mechanism based on received position information of the ironing cutting module.

9. The self-rolling tube ironing cutting device according to claim 1, wherein the ironing cutting module comprises a resistance wire and a heating controller, wherein the heating controller is used to heat the resistance wire, and the resistance wire is used to cut the tube.

10. The self-rolling tube ironing cutting device according to claim 2, further comprising a discharging mechanism disposed on the main frame, and the discharging mechanism is used to transport the self-rolling tube to the positioning member.

11. The self-rolling tube ironing cutting device according to claim 10, wherein the second feeding mechanism comprises a frame and a shaft, the frame is used to provide the self-rolling tube to the positioning member, the shaft is arranged between the frame and the positioning member, and the shaft is used to transport the self-rolling tube to the positioning member.

12. The self-rolling tube ironing cutting device according to claim 1, wherein the positioning member is spiral shaped.

13. The self-rolling tube ironing cutting device according to claim 1, wherein the positioning member is P-shaped mandrel.

14. The self-rolling tube ironing cutting device according to claim 1, wherein the positioning member is a mandrel, the self-rolling tube is sleeved on the mandrel such that overlapping portions of the wound tube have no direct contact.

15. The self-rolling tube ironing cutting device according to claim 14, wherein the first surface is inner wall of the mandrel, the second surface is outer wall of the mandrel.
